(19) United States
(12) Patent Application Publication
(10) Pub. No.: US 2018/0144108 A1
(43) Pub. Date: May 24, 2018

(54) LICENSE MANAGEMENT SYSTEM AND LICENSE MANAGEMENT METHOD

(71) Applicant: HITACHI, LTD., Tokyo (JP)

(72) Inventors: Keigo SAWAI, Tokyo (JP); Hitoshi TAKAIRA, Tokyo (JP); Kouichi KONDOU, Tokyo (JP)

(21) Appl. No.: 15/570,502

(22) PCT Filed: Jun. 3, 2015
(86) PCT No.: PCT/JP2015/066121

§ 371 Date: Oct. 30, 2017

(51) Int. Cl. G06F 21/10; G06F 8/61; G06Q 10/08; G06F 17/24

(52) U.S. Cl. CPC G06F 21/105; G06F 17/243; G06Q 10/087; G06F 8/61

(57) ABSTRACT

Proposed are a license management system and method capable of clarifying the feature of the program and accurately managing in-house IT assets. Provided is a license management system configured from a plurality of computers which execute a program, and a management server which manages a license of the program executed by the plurality of computers, wherein the plurality of computers, when the program is to be installed, acquires input information required for identifying a feature of the program, acquires window information required for identifying the feature of the program from a picture displayed on the display screen of the computer, sends the input information and the window information, including inventory information, to the management server, and wherein the management server receives the inventory information sent from the plurality of computers, and manages a license of the program being executed by the plurality of computers based on the inventory information.

### TECHNICAL FIELD

The present invention relates to a license management system and a license management method.

### BACKGROUND ART

Conventionally, known is a technology of managing in-house IT assets (IT assets used within an organization) by managing the programs installed in a plurality of computers being used in an organization. For instance, an agent is pre-installed in the plurality of computers being used by employees of a company, and the agent monitors the programs installed in the respective computers. Subsequently, each computer (each agent) sends the monitoring results (inventory information) to the management server. The management server can thereby manage the in-house IT assets by compiling the inventory information sent from the respective agents.

The technology of managing in-house IT assets has been previously disclosed in various documents, and, for instance, there are the technologies described in PTL 1 to PTL 3.

PTL 1 discloses a technology where, when an application service provided by a management server is to be used by a user of a computer, the management server causes the user of the computer to log in by using an organization code, and then log in by using a personal code. Subsequently, the management server determines whether the use is a simultaneous use by a number of users that is equal to or less than the number of contracted licenses, and thereby controls the login permission to the application service. PTL 1 describes that it is thereby possible to properly manage the application service according to the number of contracted licenses for each organization.

Moreover, PTL 2 discloses a technology where, when installing a program, which was purchased by an organization, in a plurality of in-house computers and using such program, a management server determines the appropriateness of the usage of the program by searching for the number of held licenses purchased by the organization, and the number of used licenses which were actually installed in the respective in-house computers. PTL 2 describes that it is thereby possible to compare the number of held licenses and the official number of used licenses, and realize highly accurate license management.

Furthermore, PTL 3 discloses a technology where, when a management server receives a license issue request from any one among a plurality of computers, the management server issues an overage license when there is no opening in the standard license. PTL 3 describes that it is thereby possible to enable a computer to use the application even when the computer requests the issue of a license beyond the number of normal licenses purchased in advance by the organization, and enable the management server to manage the license with minimal effort.

### CITATION LIST

### Patent Literature

[PTL 1] Japanese Patent No. 4186550
[PTL 2] Japanese Patent Application Publication No. 2008-146390
[PTL 3] Japanese Patent Application Publication No. 2010-86461

### SUMMARY OF THE INVENTION

### Problems to be Solved by the Invention

Nevertheless, with the conventional technologies described in PTL 1 to PTL 3, it is not possible to accurately manage the license of the program purchased by the organization in the following cases of [1] to [3], and the organization will be required to pay unnecessary expenses to the vendor (program provider). Thus, the challenge is to accurately manage the IT assets.

[1] When the Program has a Paid Standard Version and a Free Trial Version (Existence of Access Control)

When the license key or the program name is the same for both the paid standard version and the free trial version of the program, the management server is unable to manage the program by classifying such program as a paid standard version or a free trial version, and will manage a free trial version program as a paid standard version program. In the foregoing case, the organization will needlessly pay, to the vendor, the license fees of a license that should be free in nature.

[2] When the Version of the Program is Changed (Existence of Addition of Extension)

When the license key or the program name is the same even when the version of the program is changed, the management server is unable to manage the program upon determining the change of the version. For example, even when a program which was initially a personal version is later upgraded to a professional version, the management server will manage the program as a newly purchased professional version. In the foregoing case, the organization should have only had to pay, to the vendor, the upgrade cost, but will needlessly pay, to the vendor, the cost required for newly purchasing the professional version.

[3] When the Program can be Used in Multiple Terminals Based on One License

When a license purchased/acquired using a computer outside the organization (a personal computer) is installed in an in-house computer, the management server is unable to determine whether or not the program may be installed in a plurality of computers based on one license, and will manage the program as in-house IT assets. In the foregoing case, the organization will needlessly pay, to the vendor, the license fee of a license that does not correspond to in-house IT assets.

The present invention was devised in view of the foregoing points, and an object of this invention is propose a management system and a license management method capable of clarifying the feature of the program and accurately managing in-house IT assets.

### Means to Solve the Problems

In order to achieve the foregoing object, the present invention provides a license management system configured from a plurality of computers which execute a program, and a management server which manages a license of the program executed by the plurality of computers, wherein the plurality of computers comprise an agent which collects information related to the license of the program, wherein the agent: when the program is to be installed, determines whether or not input information required for identifying a feature of the program has been acquired, and inhibits the installation of the program when the input information has not been acquired; constantly records a picture displayed on a display screen of the computer, and acquires window information required for identifying the feature of the program from the recorded picture; sends the input information and the window information, including inventory information, to the management server, wherein the management server comprises a manager which manages the license of the program, and wherein the manager: receives inventory information sent from each agent of the plurality of computers, and manages the license of the program executed by the plurality of computers based on the inventory information.

Furthermore, in order to achieve the foregoing object, the present invention additionally provides a license management method to be executed by a plurality of computers which execute a program, and a management server which manages a license of the program executed by the plurality of computers, comprising: a first step of the plurality of computers, when the program is to be installed, determining whether or not input information required for identifying a feature of the program has been acquired, and inhibiting the installation of the program when the input information has not been acquired; a second step of the plurality of computers constantly recording a picture displayed on a display screen of the computer, and acquiring window information required for identifying the feature of the program from the recorded picture; a third step of the plurality of computers sending the input information and the window information, including inventory information, to the management server; and a fourth step of the management server receiving inventory information sent from each agent of the plurality of computers, and managing the license of the program executed by the plurality of computers based on the inventory information.

### Advantageous Effects of the Invention

According to the present invention, it is possible to clarify the feature of the program and accurately manage in-house IT assets.

### BRIEF DESCRIPTION OF DRAWINGS

FIG. 1 is an overall configuration diagram of a license management system.

FIG. 2 is an internal configuration diagram of a computer.

FIG. 3 is an internal configuration diagram of a management server.

FIG. 4 is a conceptual diagram of an installation screen and input information.

FIG. 5A is a conceptual diagram of a window and window information.

FIG. 5B is a conceptual diagram of a menu bar and window information.

FIG. 5C is a conceptual diagram of text during program activation and window information.

FIG. 6 is a conceptual diagram of old inventory information.

FIG. 7 is a conceptual configuration diagram of input information.

FIG. 8 is a conceptual configuration diagram of window information.

FIG. 9 is a conceptual configuration diagram of old inventory information.

FIG. 10 is a conceptual configuration diagram of a license management table.

FIG. 11 is a flowchart of the license management system overall processing.

FIG. 12 is a flowchart of the inventory information collection processing.

FIG. 13 is a flowchart of the input information collection processing.

FIG. 14 is a flowchart of the window information collection processing.

FIG. 15 is a flowchart of the old inventory information collection processing.

FIG. 16 is a flowchart of the inventory information transmission processing.

FIG. 17A is a flowchart of the license management table creation processing.

FIG. 17B is a flowchart of the license management table creation processing.

FIG. 17C is a flowchart of the license management table creation processing.

FIG. 17D is a flowchart of the license management table creation processing.

FIG. 17E is a flowchart of the license management table creation processing.

FIG. 18 is a flowchart of the license management table history management processing.

FIG. 19 is a conceptual diagram of the usage configuration of license management.

FIG. 20 is a conceptual configuration diagram of last execution time information.

FIG. 21 is a conceptual diagram of a search result detailed screen.

### DESCRIPTION OF EMBODIMENTS

### (1) Overall Configuration

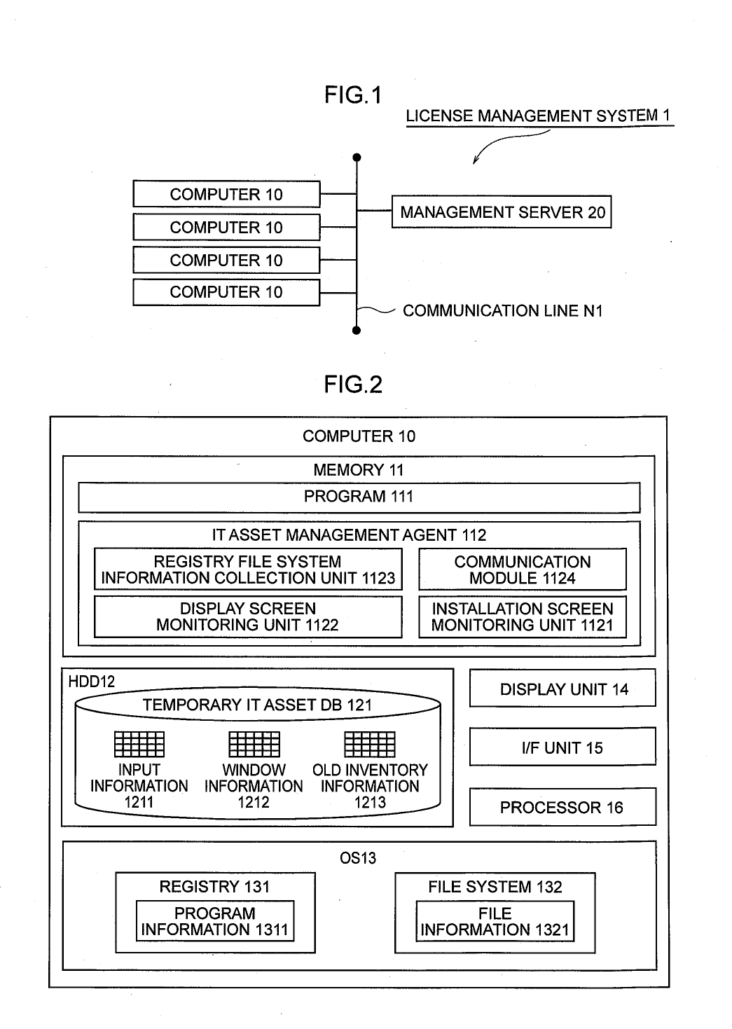

FIG. 1 shows the overall configuration of a license management system 1 in this embodiment. The license management system 1 is configured from a plurality of computers 10 and a management server 20 being communicably connected with each other via a communication line N1. While the plurality of computers 10 are hereinafter explained as computers all belonging to the same organization, the configuration is not necessarily limited thereto, and, for instance, two computers 10 may belong to organization A, and the remaining two computers 10 may belong to organization B. The management server 20 is a server which manages the license of programs for each organization.

A program referred to as an “agent” is pre-installed in each computer 10, and each agent collects input information which was input by a user of the computer 10, window information displayed on a display screen of the computer 10, and old inventory information which can be acquired based on conventional technologies, and sends the collected information to the management server 20. A program referred to as a “manager” is pre-installed in the management server 20, and the manager receives the input information, the window information and the old inventory information sent from each computer 10 (agent), and thereby manages the in-house IT assets.

### (2) Configuration of Computer

FIG. 2 shows the internal configuration of the computer 10. The computer 10 is a general computer, and is configured by comprising, for example, a memory 11, an HDD (Hard Disk Drive) 12, an OS (Operating System) 13, a display unit 14, an I/F unit 15 and a processor 16.

The memory 11 stores various types of programs 111 and an IT asset management agent 112. The various types of programs 111 are, for example, a document creation program, a spread sheet program or an email program, and are application programs that run on the OS 13. The IT asset management agent 112 is a program which manages, as IT assets, the various types of programs 111 installed in the computer 10, and is configured from an installation screen monitoring unit 1121, a display screen monitoring unit 1122, a registry file system information collection unit 1123 and a communication module 1124.

The installation screen monitoring unit 1121 causes the user of the computer 10 to input information (program name, license key and other information) related to the license of the program 111 when the program 11 is to be installed in the computer 10. The installation screen monitoring unit 1121 thereafter stores the information input by the user (this information is hereinafter referred to as the “input information”) in a temporary IT asset DB (Data Base) 121.

The display screen monitoring unit 1122 constantly records the picture displayed on the display screen of the computer 10 while the computer 10 is running. When one or more windows are included in the recorded picture, the display screen monitoring unit 1122 extracts the character strings displayed in the window or the color of the character strings, and thereafter stores the extracted information (this information is hereinafter referred to as the “window information”) in the temporary IT asset DB 121.

The registry file system information collection unit 1123 collects program information 1311 which is stored in a registry and file information 1321 which is being managed by a file system 132. The registry file system information collection unit 1123 thereafter stores the collected information (this information is hereinafter referred to as the “old inventory information”) in the temporary IT asset DB 1213.

Note that, because the information collected by the registry file system information collection unit 1123 is information that is collected by using conventional technologies, such information is referred to as “old inventory information” for differentiation from the inventory information in this embodiment. Meanwhile, the inventory information in this embodiment is information which includes the input information and the window information in addition to the old inventory information, and is referred to as “new inventory information” in comparison to the old inventory information.

The communication module 1124 sends the new inventory information (including input information, window information and old inventory information) stored in the temporary IT asset DB 121 to the management server 20. The HDD 12 is a large capacity storage device, and stores the temporary IT asset DB 121. The temporary IT asset DB 121 temporarily stores the input information 1211, the window information 1212 and the old inventory information 1213 described above.

The OS 13 is a program required for running the program 111, and is a program which manages the overall computer 10. FIG. 2 illustrates a specific case where the OS 13 is managing a registry 131 and a file system 132. The registry 131 stores program information 1311 including, for instance, information related to the program provider (vendor name) and the license key of the program 111. Moreover, the file system 132 stores file information 1321 includes, for instance, the file name.

The display unit 14 is, for example, a display device comprising a display screen such as an LCD (Liquid Crystal Display). The I/F unit 15 is, for example, a communication unit such as an NIC (Network Interface Card), and is also a user interface of a keyboard or a mouse. The processor 16 is, for example, a CPU (Central Processing Unit), and controls the overall operation of the computer 10 by coordinating with the program 111 and the IT asset management agent 112 stored in the memory 11.

### (3) Configuration of Management Server

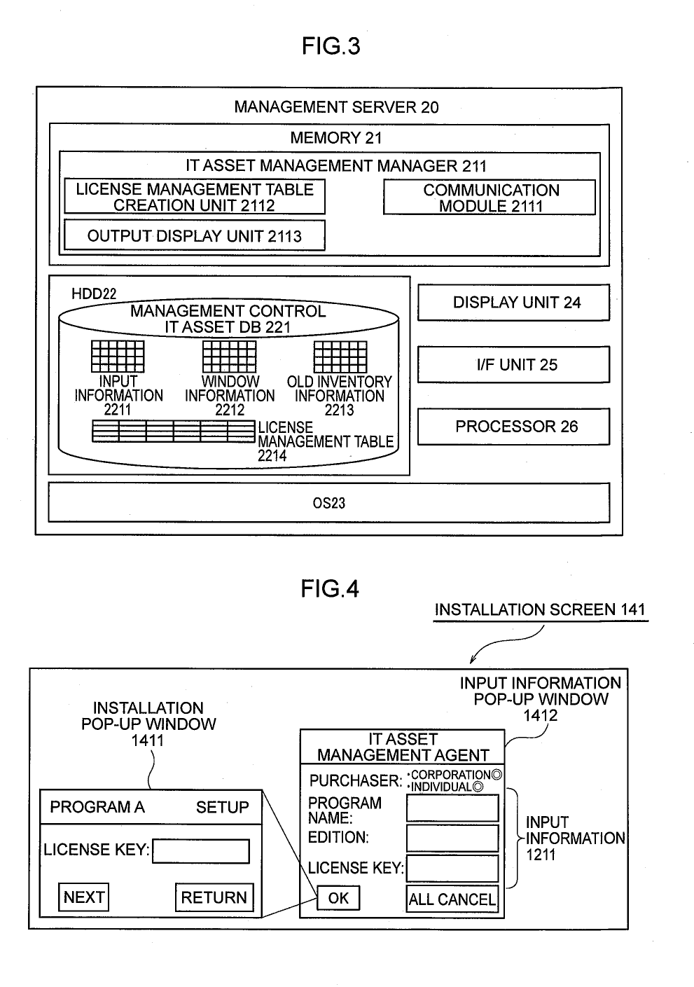

FIG. 3 shows the internal configuration of the management server 20. The management server 20 is a general computer, and comprises, for example, a memory 21, an HDD 22, an OS 23, a display unit 24, an I/F unit 25 and a processor 26.

The memory 21 stores an IT asset management manager 211. The IT asset management manager 211 is a program which manages, as IT assets, the various types of programs 111 installed in the respective computers 10 in an organization, and is configured from a communication module 2111, a license management table creation unit 2112 and an output display unit 2113.

The communication module 2111 receives the new inventory information sent from each computer 10 and stores the received new inventory information in a management control IT asset DB 221. The license management table creation unit 2112 creates a license management table 2214 for managing the in-house licenses based on the new inventory information (2211 to 2213) from each computer 10 stored in the management control IT asset DB 221. The output display unit 2113 displays on a display screen of a display unit 24, or outputs to an external terminal, the new inventory information (2211 to 2213) or the license management table 2214 stored in the management control IT asset DB 221.

The HDD 22 is a large capacity storage device, and stores the management control IT asset DB 221. The new inventory information from each computer 10 explained above is complied and stored in the management control IT asset DB 221. Note that the term “new inventory information” as used herein refers to all of the input information 2211, the window information 2212 and the old inventory information 2213 sent from each computer 10. Moreover, the license management table 2214 is also stored in the management control IT asset DB 221.

The OS 23 is a program required for running the various types of programs stored in the memory 21, and is a program which manages the overall management server 20. The display unit 24 is, for example, a display device comprising a display screen such as an LCD, and the I/F unit 25 is, for example, an NIC or an interface of a keyboard or a mouse. Moreover, the processor 26 is, for example, a CPU, and controls the overall operation of the management server 20 by coordinating with the various types of programs stored in the memory 21.

### (4) Configuration of Screen Configuration and Inventory Information

The schematic configuration of the new inventory information in this embodiment is now explained with reference to FIG. 4 to FIG. 6. The new inventory information in this embodiment is configured by including the input information 1211, the window information 1212 and the old inventory information 1213.

FIG. 4 shows an installation screen 141 displayed on the display unit 14 of the computer 10. The input information 1211 is collected from the installation screen 141. The installation screen 141 is a screen that is displayed upon installing a new program 111 in the computer 10, and is configured from an installation pop-up window 1411 and an input information pop-up window 1412.

When the new program 111 is to be installed in the computer 10, the installation pop-up window 1411 is foremost displayed on the display unit 14. When the display of the installation pop-up window 1411 is detected by the installation screen monitoring unit 1121, input operation to the installation pop-up window 1411 is disabled, and the input information pop-up window 1412 is displayed on the display unit 14.

The input information pop-up window 1412 displays a radio button or an empty column for causing the user to input information such as purchaser classification (corporation or individual), program name, edition (paid, free, version, revision) and license key of the program 111 to be installed. Other radio buttons or empty columns for inputting other information (for instance, vendor name) may also be displayed. Moreover, an “OK” button for setting the input information and an “All cancel” button for cancelling the input information are displayed.

When the user presses the radio button on the input information pop-up window 1412, inputs information in the respective empty columns, and thereafter presses the “OK” button, the installation screen monitoring unit 1121 cancels the disablement of the installation pop-up window 1411, and the license key input to the input information pop-up window 1412 is copied onto the installation pop-up window 1411. Moreover, the information input to the input information pop-up window 1412 is collected as the input information 1211 by the installation screen monitoring unit 1121, and stored in the temporary IT asset DB 121.

Meanwhile, when the user presses the “All cancel” button on the input information pop-up window 1412, the installation screen monitoring unit 1121 closes the installation pop-up window 1411 and the input information pop-up window 1412, and the installation of the program 111 is inhibited. In other words, the configuration does not allow the program 111 to be installed when it is not possible to collect the input information 1211.

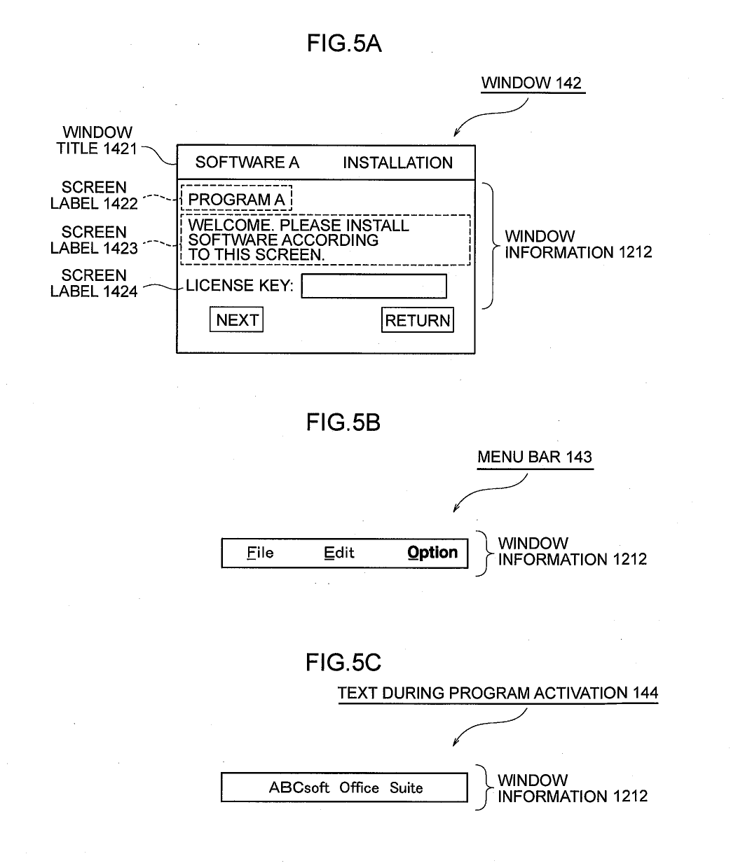

FIG. 5A to FIG. 5C show a window 142, a menu bar 143 and a text during program activation 144 displayed on the display unit 14 of the computer 10. The window information 1212 is collected from the window 142, the menu bar 143 and the text during program activation 144.

The window 142 of FIG. 5A is an object configuring a part of the screen displayed on the display unit 14 when a new program 111 is to be installed in the computer 10. The window 142 displays a window title 1421 and screen labels 1422 to 1424. The window title 1421 and the screen labels 1422 to 1424 are collected as the window information 1212 by the display screen monitoring unit 1122, and stored in the temporary IT asset DB 121.

The menu bar 143 of FIG. 5B is an object which is displayed while the program 111 previously installed in the computer 10 is being executed. The menu bar 143 displays a text of a plurality of menus. The color of text of the menus differs between available menus and unavailable menus.

For example, in the case shown in FIG. 5B, the available menus are “File” and “Edit”, and the unavailable menu is “Option”. The color of text differs between “File” and “Edit”, and “Option”. Upon upgrading to a paid standard version, for instance, the color of text of “Option” is changed, and the option function becomes available. In addition to the text of the menu, the color of the text is also collected as the window information 1212 by the display screen monitoring unit 1122, and stored in the temporary IT asset DB 121.

The text during program activation 144 of FIG. 5C is an object configuring a part of the screen that is temporarily displayed upon activating the program 111 previously installed in the computer 10. The text during program activation 144 generally displays the product name and edition. The product name and edition are collected as the window information 1212 by the display screen monitoring unit 1122, and stored in the temporary IT asset DB 121.

Note that the window 142, the menu bar 143 and the text during program activation 144 shown in FIG. 5A to FIG. 5C are examples of objects displayed on the display unit 14, and various other objects such as window title, menu, label, and button are also displayed on the display unit 14. All objects displayed on the display unit 14, excluding same objects, are collected by the display screen monitoring unit 1122 for each window, and stored in the temporary IT asset DB 121.

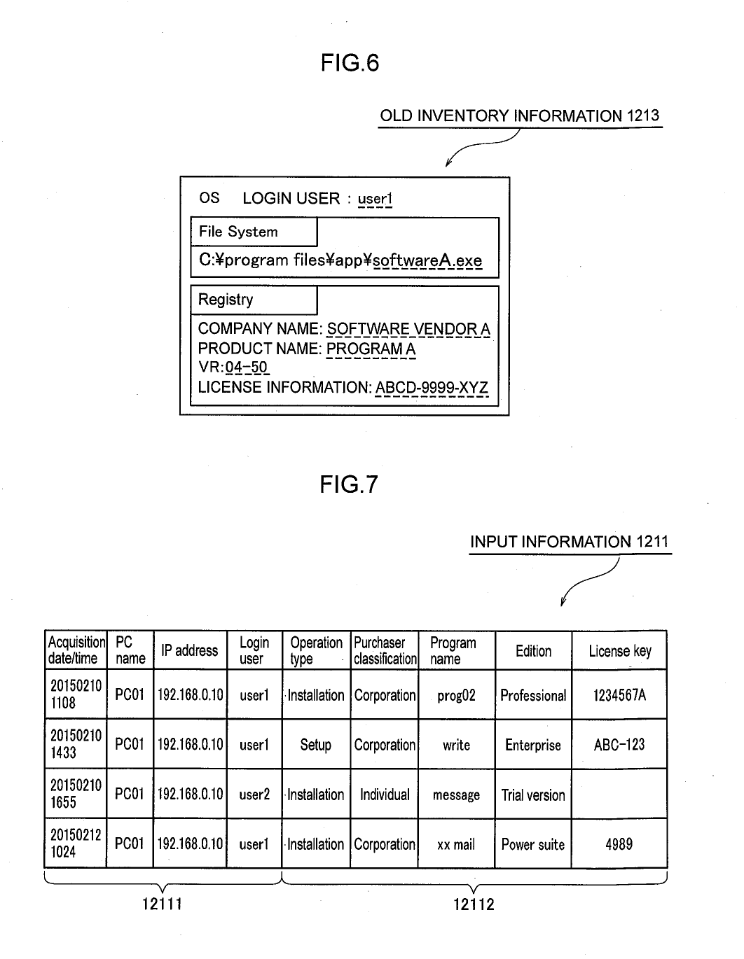

FIG. 6 shows a conceptual configuration of the old inventory information 1213 collected from the registry 131 and the file system 132 of the computer 10. The old inventory information 1213 is information including login user name, file name, program provider (vendor name), program name, VR (version/revision information) and license information of the program 111, and is collected by the registry file system information collection unit 1123 and stored in the temporary IT asset DB 121.

### (5) Detailed Configuration of New Inventory Information and License Management Table

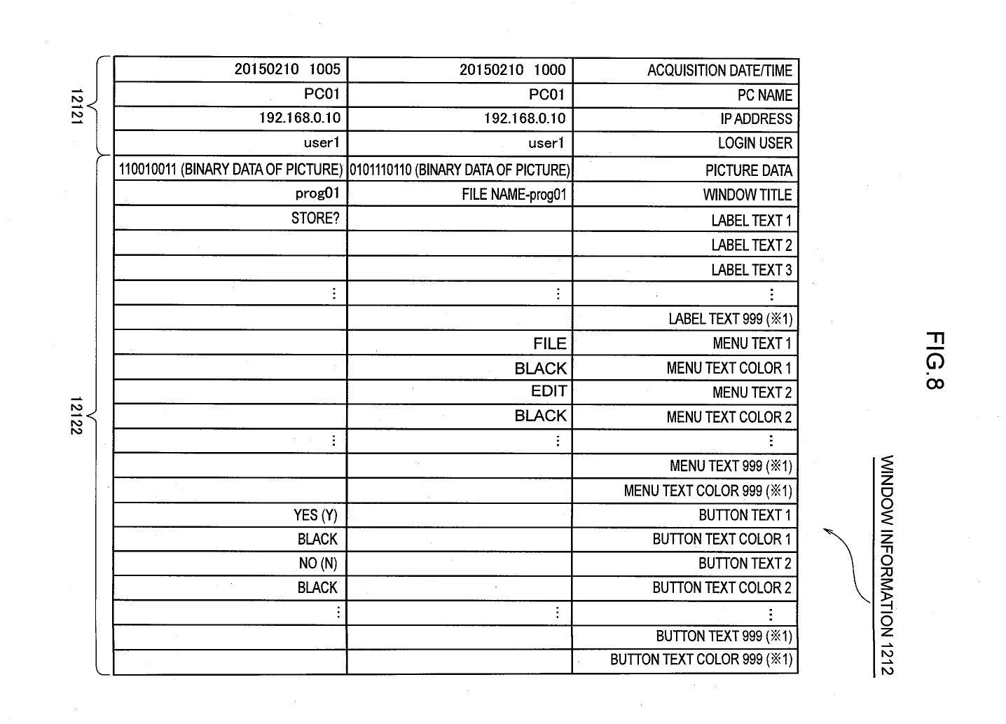

The detailed configuration of the new inventory information (1211 to 1213) and the license management table 2214 is now explained with reference to FIG. 7 to FIG. 10. As explained above, the new inventory information is information including the input information 1211, the window information 1212 and the old inventory information 1213 collected from each computer 10. Meanwhile, the license management table 2214 is information created by the management server 20 based on the new inventory information collected from each computer 10. This is now explained in sequence.

FIG. 7 shows a conceptual configuration of the input information 1211. The input information 1211 is information collected by the installation screen monitoring unit 1121 of each computer 10 and temporarily stored in the temporary IT asset DB 121, and is configured from a header column 12111 and a screen input column 12112

The header column 12111 stores general information related to the input information 1211. Here, general information refers to information such as date/time, computer name (PC name), IP address and login user acquired as the input information 1211. Moreover, the screen input column 12112 stores information that the user input on the installation screen 141. Specifically, information related to the operation type (installation or setup), purchaser classification, program name, edition and license key is stored.

Accordingly, in the case of FIG. 7, for example, the input information 1211 acquired at “11:08 on Feb. 10, 2015” is information input by a user having a login user name of “user1” in the computer 10 having a computer name of “PC01” and an IP address of “192.168.0.10”.

Moreover, FIG. 7 shows that the input information 1211 is information acquired at the time of “installation”, and shows that the purchaser classification of the program 111 is “corporation”, the program name of the program to be installed is “prog02”, the edition is “professional”, and the license key is “1234567A”.

FIG. 8 shows a conceptual configuration of the window information 1212. The window information 1212 is information collected by the display screen monitoring unit 1122 of each computer 10 and temporarily stored in the temporary IT asset DB 121, and is configured from a header column 12121 and a picture extraction column 12122.

The header column 12121 stores general information related to the window information 1212. Here, similar to FIG. 7, general information refers to information such as date/time, computer name (PC name), IP address and login user acquired as the window information 1212. Moreover, the picture extraction column 12122 stores the picture itself (picture data) and various types of information extracted from the picture. Specifically, the picture data is stored as binary data. Moreover, the various types of information extracted from the picture are, for example, window title, label text, menu text, menu text color, button text and button text color.

Accordingly, in the case of FIG. 8, for example, the window information 1212 acquired at “10:00 on Feb. 10, 2015” is information input by a user having a login user name of “user1” in the computer 10 having a computer name of “PC01” and an IP address of “192.168.0.10”.

Moreover, FIG. 8 shows that the window information 1212 includes the picture data, and shows that a window title of “file name.prog01”, a menu text of “file”, and the menu text being “black” are included as information.

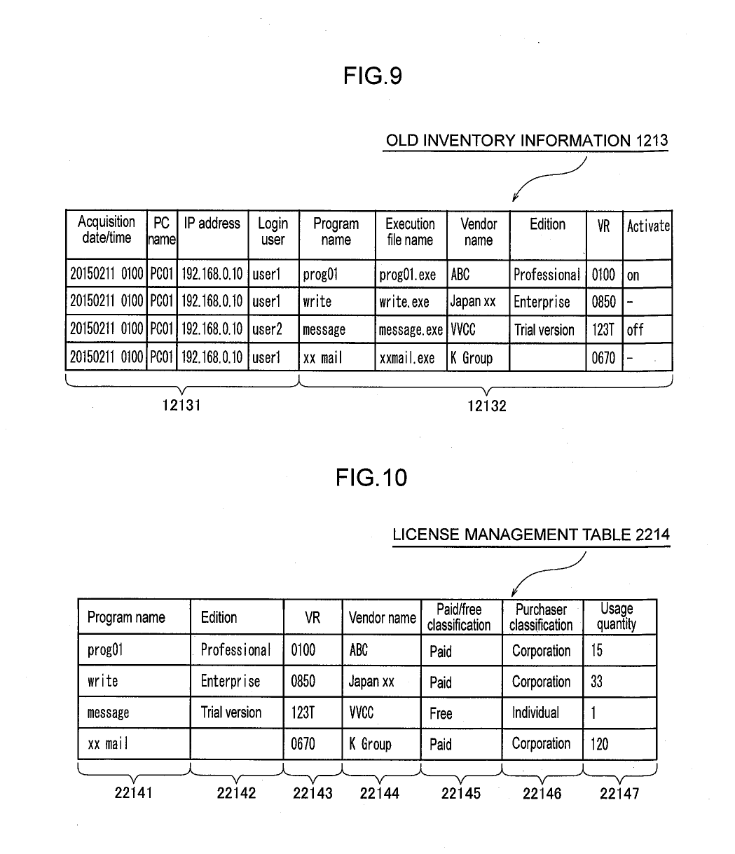

FIG. 9 shows a conceptual configuration of the old inventory information 1213. The old inventory information 1213 is information collected by the registry file system information collection unit 1123 of each computer 10 and temporarily stored in the temporary IT asset DB 121, and is configured from a header column 12131 and a registry file system collection column 12132.

The header column 12131 stores general information related to the old inventory information 1213. Here, similar to FIG. 7, general information refers to information such as date/time, computer name (PC name), IP address and login user acquired as the old inventory information 1213. Moreover, the registry file system collection column 12132 stores information collected from the registry 131 and the file system 132. Specifically, the registry file system collection column 12132 stores information such as program name, execution file name, vendor name, edition, VR (version/revision) and Activate (execution state).

Accordingly, in the case of FIG. 9, for example, the old inventory information 1213 acquired at “01:00 on Feb. 11, 2015” is information input by a user having a login user name of “user1” in the computer 10 having a computer name of “PC01” and an IP address of “192.168.0.10”.

Moreover, the old inventory information 1213 of FIG. 9 shows that, with regard to the program having a program name of “prog01”, the execution file name is “prog01.exe”, the program provider (vendor) is “ABC”, the edition is “professional”, VR is “0100”, and the program is in an executable state (Activate: “ON”).

FIG. 10 shows a conceptual configuration of the license management table 2214. The license management table 2214 is information created by the license management table creation unit 2112 of the management server 20 based on the new inventory information which includes the input information 1211 (FIG. 7), the window information 1212 (FIG. 8) and the old inventory information 1213 (FIG. 9) collected from each computer 10.

The license management table 2214 is configured from a program name column 22141, an edition column 22142, a VR column 22143, a vendor name column 22144, a paid/free classification column 22145, a purchase classification column 22146 and a usage quantity column 22147. The program name column 22141 stores the program name of the program being used (by some or all of the computers 10) in the organization. The edition column 22142 stores the edition of the program. The VR column 22143 stores the version or revision of the program. The vendor name column 22144 stores the vendor name of the program provider.

The paid/free classification column 22145 stores information regarding whether the program is a paid standard version or a free trial version. The purchase classification column 22146 stores information indicating whether the purchase of the program is a corporation or an individual. The usage quantity column 22147 stores the license usage quantity of the program being used in the organization.

Accordingly, for example, the license management table 2214 of FIG. 10 shows that, with regard to the program having a program name of “prog01”, the edition is “Professional”, VR is “0100”, and the program provider (vendor name) is “ABC”. Moreover, the license management table 2214 shows that the program is “paid” and was purchased by a “corporation”, and the license usage quantity in the organization is “15” licenses.

### (6) Flowcharts

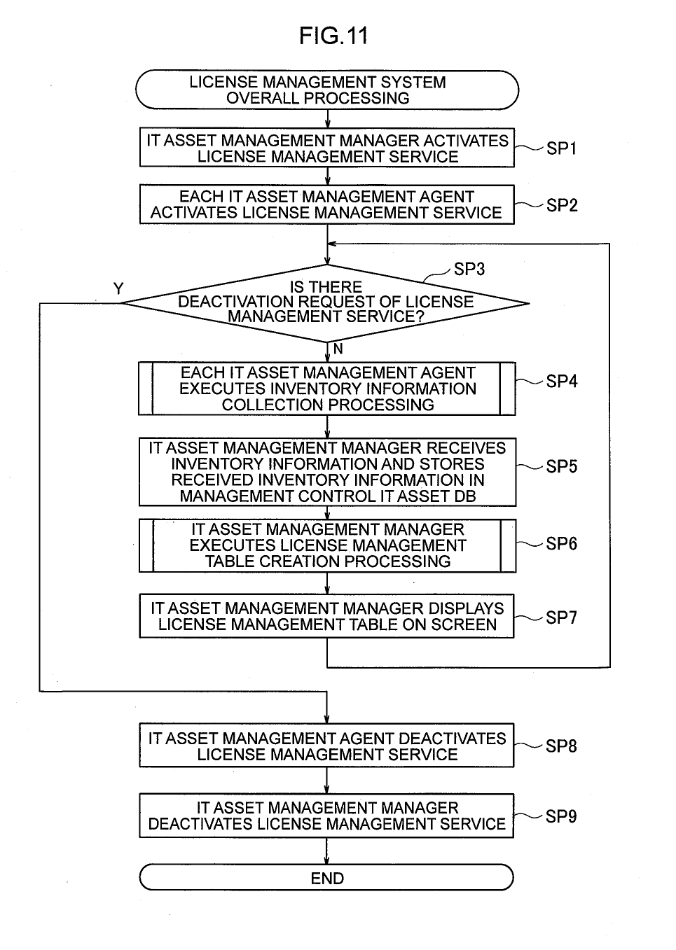

The processing contents of the IT asset management agent 112 and the IT asset management manager 211 are now explained with reference to FIG. 11 to FIG. 18. Note that, while each type of processing explained below is executed based on the coordination of the processor 16 and the IT asset management agent 112, or the coordination of the processor 26 and the IT asset management manager 211, for the sake of facilitating the explanation, the processing entity will be explained as the respective components of the IT asset management agent 112 or the respective components of the IT asset management manager 211.

FIG. 11 shows a flowchart of the license management system overall processing. The overall processing is executed by the IT asset management agent 112 or the IT asset management manager 211 on the condition that the installation of the IT asset management agent 112 in the computer 10 is complete, and the installation of the IT asset management manager 211 in the management server 20 is also complete.

Foremost, the IT asset management manager 211 of the management server 20 activates a license management service for managing the licenses (SP1). Next, each IT asset management agent 112 in all computers 10 in the organization similarly activates the license management service (SP2).

The license management service is started in the license management system 1 as a result of step SP1 and step SP2 being executed. The started license management service is constantly continued until the IT asset management manager 211 or the IT asset management agent 112 receives a deactivation request (SP3: N). While the license management service is being continued, each IT asset management agent 112 of each computer 10 executes the inventory information collection processing (SP4).

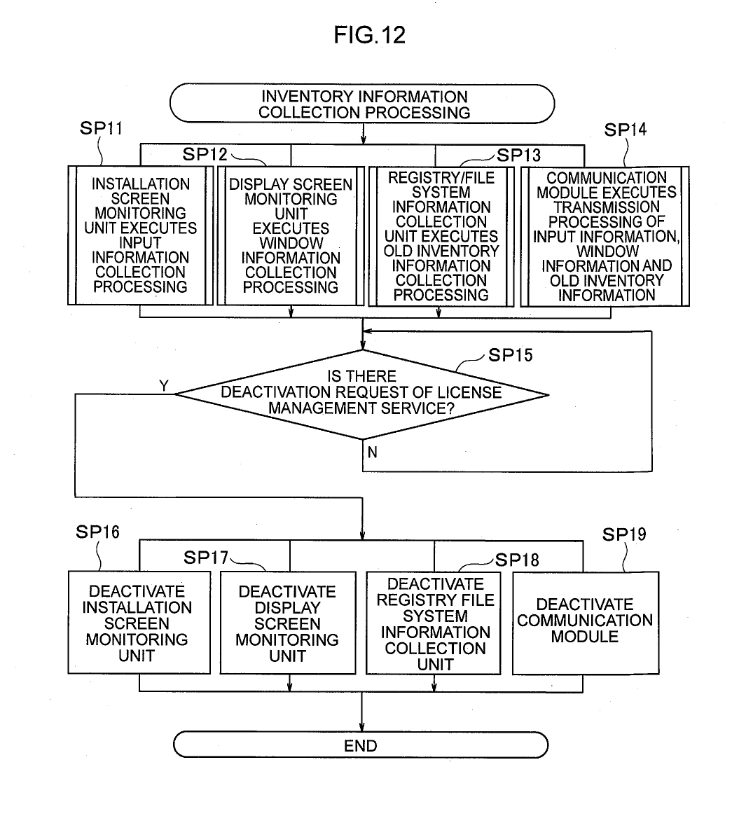

While the details of the inventory information collection processing will be described later (FIG. 12), the following is a brief explanation. Foremost, the components 1121 to 1123 of the IT asset management agent 112 respectively collect the input information 1211, the window information 1212 and the old inventory information 1213, and store the collected information in the temporary IT asset DB 121. Next, the communication module 1124 sends, to the management server 20, the various types of information stored in the temporary IT asset DB 121 as the new inventory information.

The IT asset management manager 211 of the management server 20 receives the new inventory information sent from each computer 10, and compiles and stores the received new inventory information in the management control IT asset DB 221 (SP5). Subsequently, the IT asset management manager 211 executes the license management table creation processing (SP6). In the license management table creation processing, the IT asset management manager 211 creates the license management table 2214.

The IT asset management manager 211 displays the license management table 2214 created in step SP6 on the screen according to the user's operation or request (SP7). The IT asset management manager 211 thereafter returns to step SP3, and repeats the foregoing processing (SP4 to step SP7) until a deactivation request of the license management service is received.

When the IT asset management manager 211 or the IT asset management agent 112 receives a deactivation request of the license management service (SP3: Y), each IT asset management agent 112 deactivates the license management service (SP8), Moreover, the IT asset management manager 211 also deactivates the license management service (SP9), and then ends this processing.

FIG. 12 shows a flowchart of the inventory information collection processing. The inventory information collection processing is executed by the IT asset management agent 112 when the processing in the overall processing (FIG. 11) proceeds to step SP4.

The IT asset management agent 112 executes the input information collection processing based on the installation screen monitoring unit 1121 (SP11), executes the window information collection processing based on the display screen monitoring unit 1122 (SP12), and executes the old inventory information collection processing based on the registry file system information collection unit 1123 (SP13). Moreover, IT asset management agent 112 executes the transmission processing of sending the inventory information collected in step SP11 to step SP13 based on the communication module 1124 (SP14).

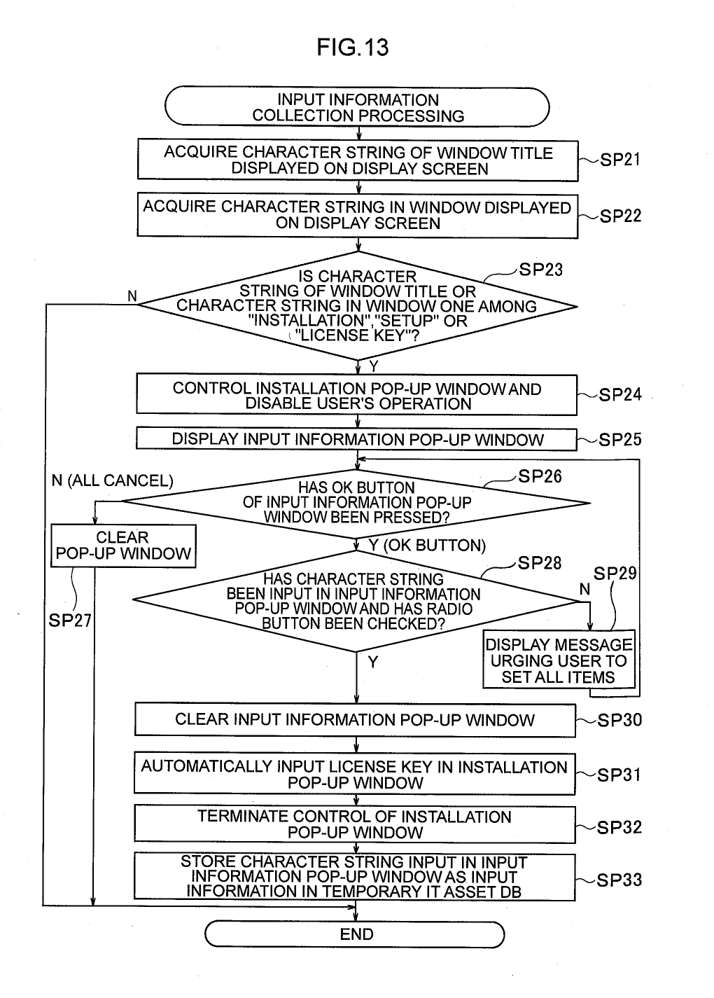

The details of the processing of step SP11 to step SP14 will be described later (FIG. 13 to FIG. 16). The processing order of the foregoing processing is not limited to the order explained above, and, for example, after the input information is collected (SP11), the transmission processing may be executed as needed (SP14).

Next, the IT asset management agent 112 determines whether there is a deactivation request of the license management service (SP15). Upon obtaining a negative result in the foregoing determination (SP15: N), the IT asset management agent 112 stands by until a deactivation request is received.

Meanwhile, upon obtaining a positive result in the foregoing determination (SP15: Y), the IT asset management agent 112 deactivates the installation screen monitoring unit 1121 (SP16), deactivates the display screen monitoring unit 1122 (SP17), deactivates the registry file system information collection unit 1123 (SP18), deactivates the communication module 1124 (SP19), and then ends this processing.

FIG. 13 shows a flowchart of the input information collection processing. The input information collection processing is executed by the installation screen monitoring unit 1121 of the IT asset management agent 112 when the processing in the inventory information collection processing (FIG. 12) proceeds to step SP11 and the program installation screen is displayed on the display screen of the computer 10.

The installation screen monitoring unit 1121 is constantly monitoring the display screen displayed on the display unit 14 of the computer 10, and, when a window is displayed on the display screen being monitored, acquires the character string of the window title displayed on the display screen (SP21). Moreover, the installation screen monitoring unit 1121 acquires the character string in the window (SP22).

Subsequently, the installation screen monitoring unit 1121 determines whether the acquired character string of the window title or the character string in the window is any one among “installation”, “setup” or “license key” (SP23). Upon obtaining a negative result in the foregoing determination (SP23: N), the installation screen monitoring unit 1121 determines that the currently displayed screen is not the program installation screen, and then ends this processing.

Meanwhile, upon obtaining a positive result in the determination of step SP23 (SP23: Y), the installation screen monitoring unit 1121 determines that the currently displayed screen is the program installation screen, controls the installation pop-up window 1411 (FIG. 4), and disables the user's operations to the installation pop-up window 1411 (SP24).

Next, the installation screen monitoring unit 1121 displays the input information pop-up window 1412 (FIG. 4) on the display screen (SP25). Subsequently, the installation screen monitoring unit 1121 determines whether the “OK” button displayed on the input information pop-up window 1412 has been pressed (SP26). Upon obtaining a negative result in the foregoing determination (SP26: N); that is, when the “All cancel” button has been pressed, the installation screen monitoring unit 1121 clears the pop-up windows 1411 and 1412 from the display screen (SP27), and then ends this processing.

Based on the processing of step SP27, unless the user inputs the input information 1211, it is not possible to install a new program 111 in the computer 10. In other words, it is necessary to collect the input information 1211 in order to install a new program 111

Meanwhile, upon obtaining a positive result in the determination of step SP26 (SP26: Y), the installation screen monitoring unit 1121 determines whether character strings have been input in all empty columns in the input information pop-up window 1412 and whether the radio button has been checked (SP28). Upon obtaining a negative result in the foregoing determination (SP28: N), the installation screen monitoring unit 1121 displays a message on the display screen urging the user to set all items (SP29), and then returns to step SP26.

Meanwhile, upon obtaining a positive result in the determination of step SP28 (SP28: Y), the installation screen monitoring unit 1121 clears the input information pop-up window 1412 from the display screen (SP30), and copies the license key, which was input in the input information pop-up window 1412, onto the installation pop-up window 1411 (SP31). The installation screen monitoring unit 1121 thereafter cancels the control of the installation pop-up window 1411 (SP32).

Finally, the installation screen monitoring unit 1121 collects, as the input information 1211, the character strings input in the input information pop-up window 1412 and stores input information 1211 in the temporary IT asset DB 121 (SP33), and then ends this processing.

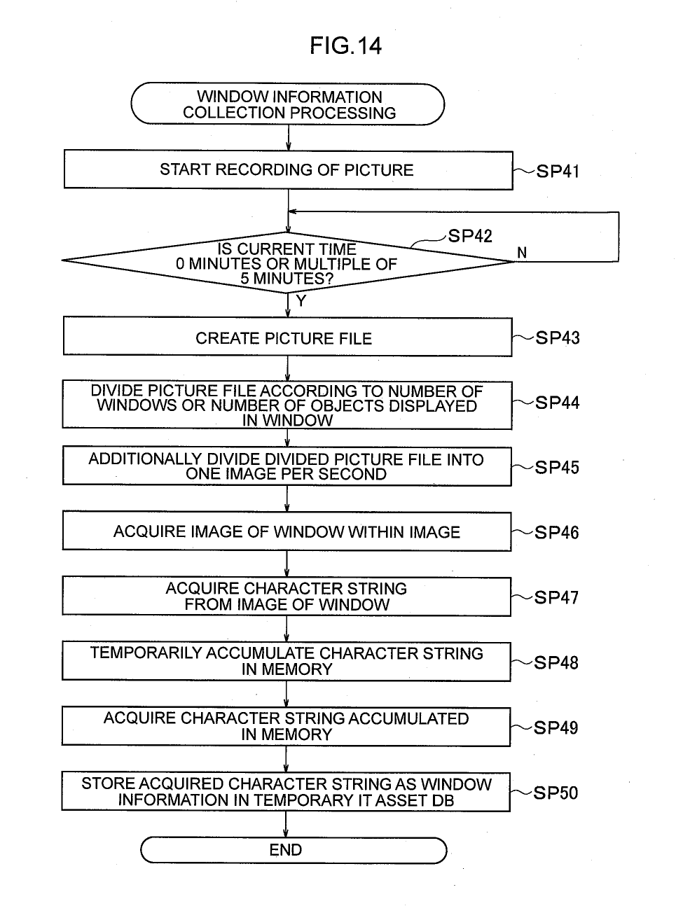

FIG. 14 shows a flowchart of the window information collection processing. The window information collection processing is executed by the display screen monitoring unit 1122 of the IT asset management agent 112 when the processing in inventory information collection processing (FIG. 12) proceeds to step SP12 and a picture is displayed on the display screen of the computer 10.

The display screen monitoring unit 1122 is constantly monitoring the display screen displayed on the display unit 14 of the computer 10, and records all pictures displayed on the display screen being monitored (SP41). Next, the display screen monitoring unit 1122 determines whether the current time is 0 minutes or a multiple of 5 minutes (SP42). Note that the processing of step SP42 is for separating the recorded picture into predetermined units so as to facilitating the execution of subsequent processing, and does not necessary need to be separated into 0 minutes or a multiple of 5 minutes.

Upon obtaining a negative result in the determination of step SP42 (SP42: N), the display screen monitoring unit 1122 continues to record pictures until pictures of predetermined units are acquired. Meanwhile, upon obtaining a positive result in the foregoing determination (SP42: Y), the display screen monitoring unit 1122 creates a picture file of predetermined units (SP43). Next, the display screen monitoring unit 1122 additionally divides the created picture file of predetermined units into units for further facilitating the processing according to the number of windows or the number of objects displayed in the windows (SP44).

For example, in cases where one window A is displayed between time t0 to time t2 and two windows (window A and window B) are displayed between time t2 to time t5 in the picture file created in step SP43; that is, in cases where window B has been added and is being displayed from time t2 onward, the display screen monitoring unit 1122 divides the picture file at time t2.

Moreover, in cases where one window A is displayed between time t0 to time t2 in the picture file created step SP43, when window A is changed as a result of the “Next” button in window A being pressed and the object (character string or the like) in window A is changed at time t1, the display screen monitoring unit 1122 divides the picture file at time t1.

Next, after dividing the picture file in window units, the display screen monitoring unit 1122 additionally divides the divided picture file into one image per second to facilitate the processing (SP45), and acquires the image of the window within the image per second (SP46). Subsequently, the display screen monitoring unit 1122 acquires the character strings from the image of the window (SP47), and temporarily stores the acquired character strings in the memory 11 (SP48).

Next, the display screen monitoring unit 1122 acquires the character strings stored in the memory 11 (SP49). Here, with regard to similar character strings, the display screen monitoring unit 1122 acquires, from the memory 11, only the character string that was displayed last; that is, the character string with the latest display time.

For example, in cases where a character string x is displayed on an image A per second, a character string xy is displayed on an image B one second later, and a character string xyz is displayed on an image C another second layer, while the display screen monitoring unit 1122 once stores all of these character strings in the memory 11 (SP47, SP48), the display screen monitoring unit 1122 thereafter acquires, from the memory 11, only the character string xyz acquired from the image C (SP49).

Finally, the display screen monitoring unit 1122 stores the character string acquired from the memory 11 as the window information 1212 in the temporary IT asset DB 121 (SP50), and then ends this processing.

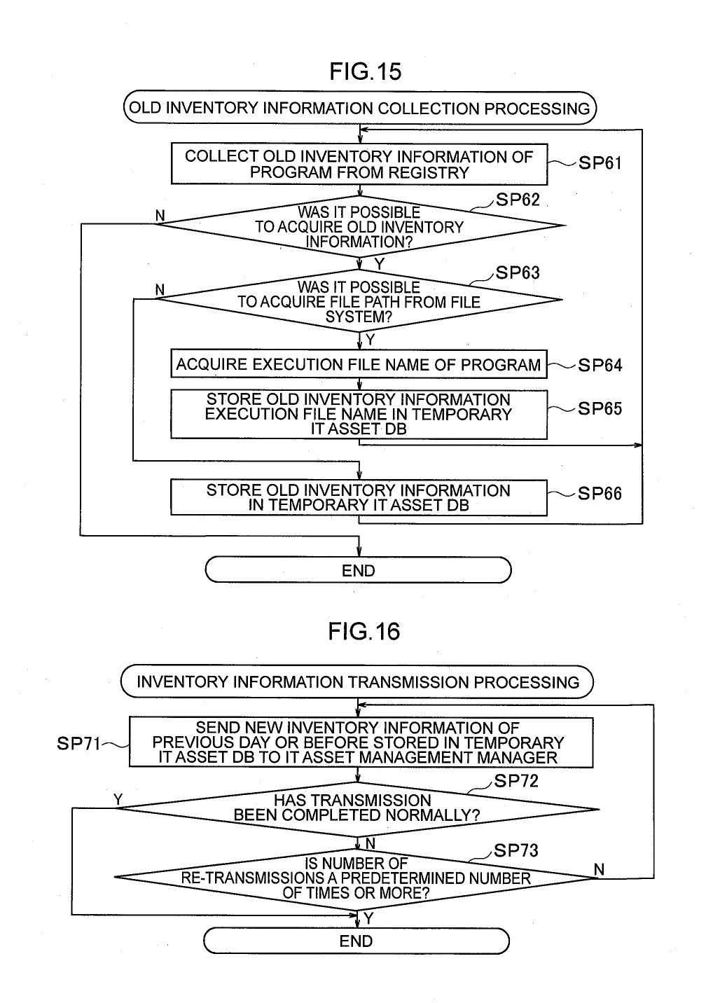

FIG. 15 shows a flowchart of the old inventory information collection processing. The old inventory information collection processing is executed by the registry file system information collection unit 1123 of the IT asset management agent 112 when the processing in the inventory information collection processing (FIG. 12) proceeds to step SP13 and a predetermined set time has elapsed.

The registry file system information collection unit 1123 collects the old inventory information from the program information 1311 of the registry 131 (SP61). Next, the registry file system information collection unit 1123 determines whether it was possible to collect the old inventory information (SP62).

When the registry file system information collection unit 1123 obtains a positive result in the determination of step SP62 (SP62: Y), the registry file system information collection unit 1123 determines whether it was possible to acquire a file path from the file information 1321 of the file system 132 (SP63).

Upon obtaining a positive result in the determination of step SP63 (SP63: Y), the registry file system information collection unit 1123 acquires the execution file name of the program (SP64). Next, the registry file system information collection unit 1123 stores the old inventory information and the execution file name in the temporary IT asset DB 121 (SP65), and then returns to step SP61.

Meanwhile, upon obtaining a negative result in the determination of step SP63 (SP63: N), the registry file system information collection unit 1123 stores the old inventory information in the temporary IT asset DB 121 (SP66), and then returns to step SP61. When the registry file system information collection unit 1123 completes the collection of all old inventory information from the registry 131 (SP61, SP62: N), the registry file system information collection unit 1123 ends this processing.

FIG. 16 shows a flowchart of the inventory information transmission processing. The inventory information transmission processing is executed by the communication module 1124 of the IT asset management agent 112 when the processing in the inventory information collection processing (FIG. 12) proceeds to step SP14 and a predetermined set time has elapsed.

The communication module 1124 sends, to the IT asset management manager 211, the new inventory information of the previous day or before stored in the temporary IT asset DB 121 (SP71). The reason why the new inventory information to be sent is of the previous day or before is because the new inventory information of the current day has not yet been determined.

The communication module 1124 determines whether the transmission was completed normally (SP72). Upon obtaining a positive result in the foregoing determination, the communication module 1124 determines that the new inventory information has been sent normally, and then ends this processing. Meanwhile, upon obtaining a negative result in the foregoing determination (SP72: N), the communication module 1124 determines whether the number of re-transmissions is a predetermined number of times (for instance, 3 times) or more (SP73).

Upon obtaining a positive result in the determination of step SP73 (SP73: Y), the communication module 1124 determines that the new inventory information cannot be sent due to some kind of communication failure, and then ends this processing. Note that, here, an error screen for notifying that the transmission of the new inventory information was unsuccessful may be displayed on the display unit 14.

Meanwhile, upon obtaining a negative result in the determination of step SP73 (SP73: N), the communication module 1124 proceeds to step SP71 and once against sends the inventory information. If it was possible to send the inventory information based on a re-transmission within a predetermined number of times, the communication module 1124 ends this processing.

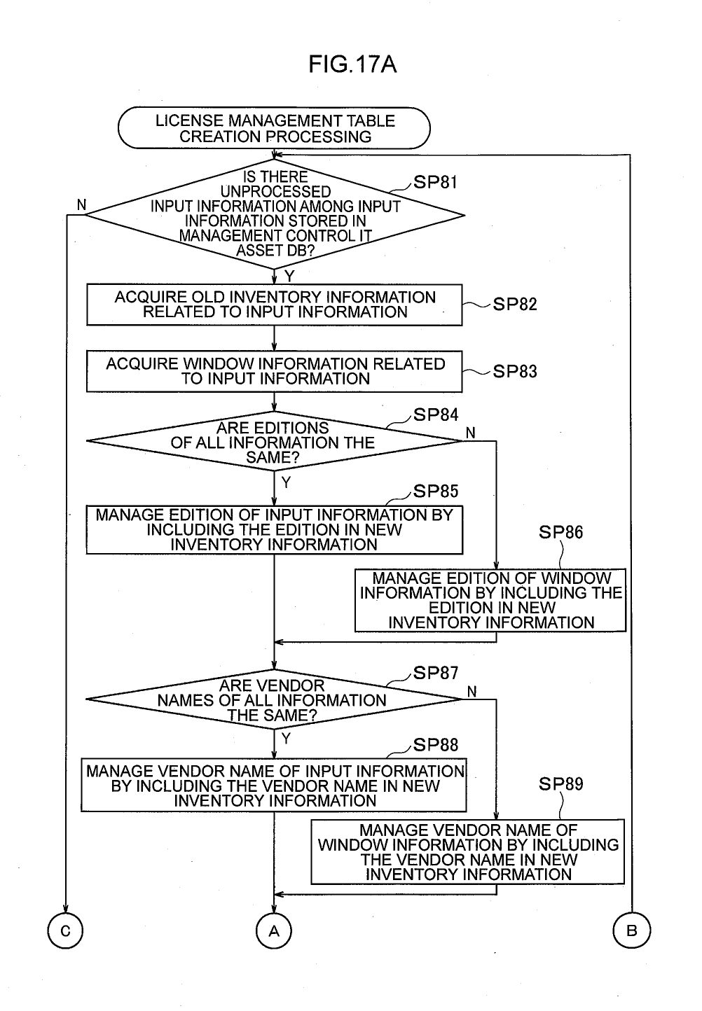

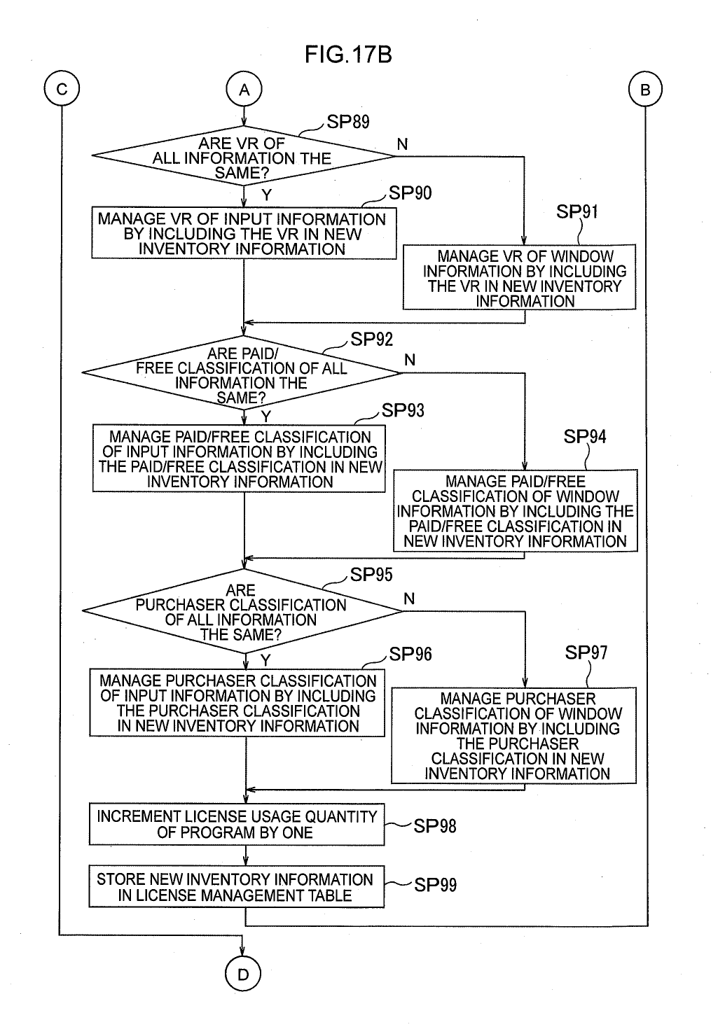

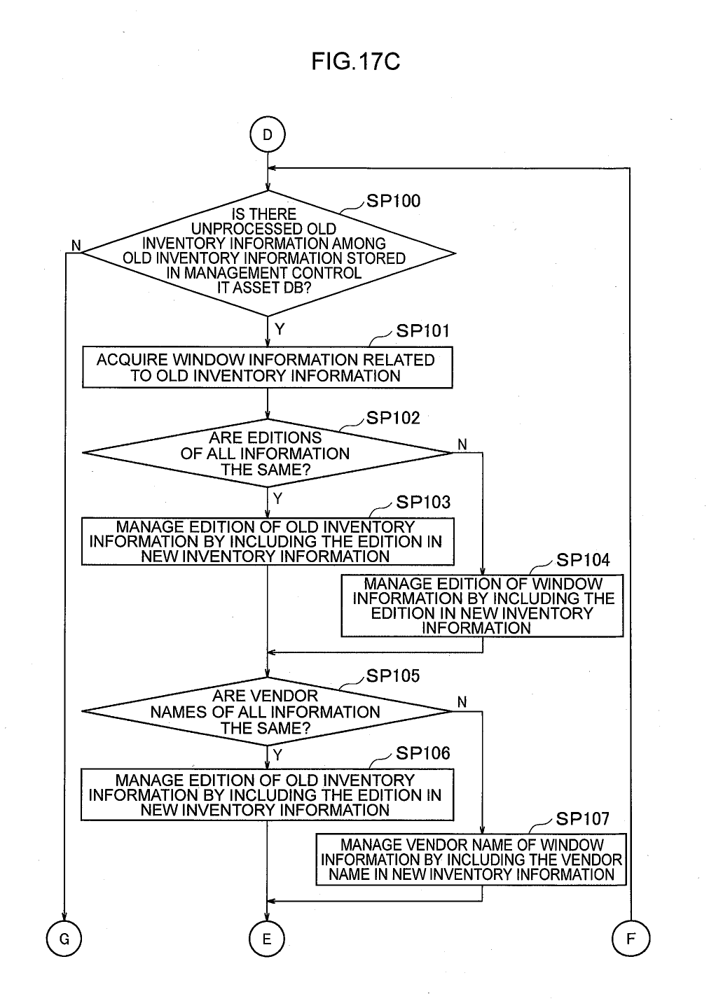

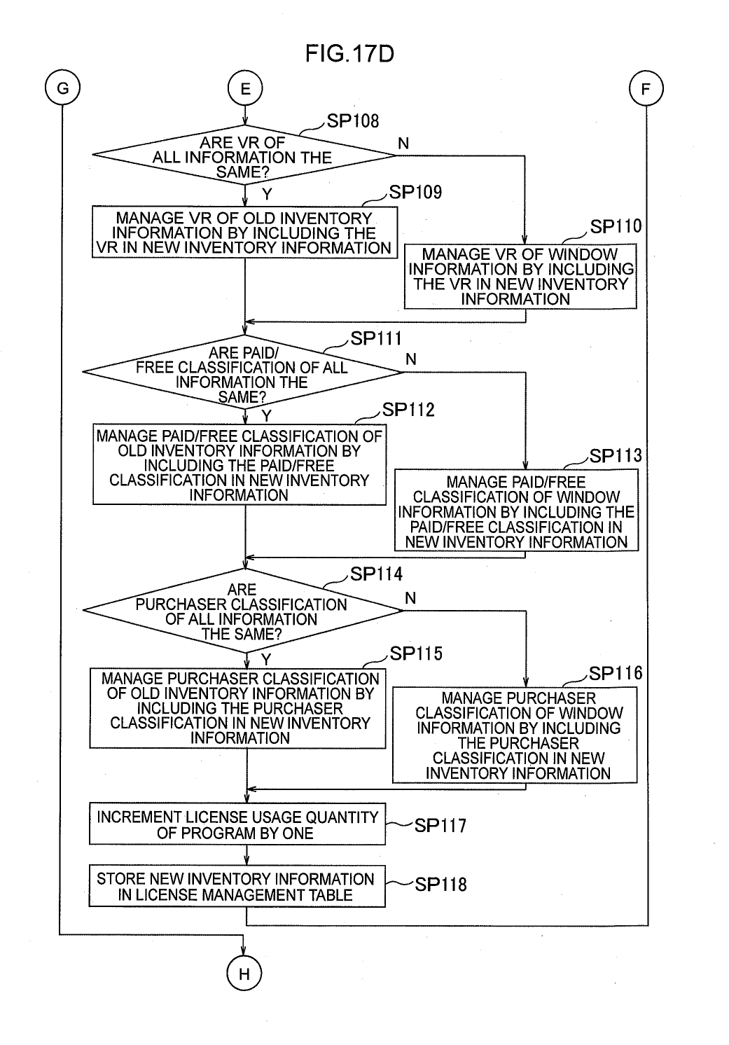

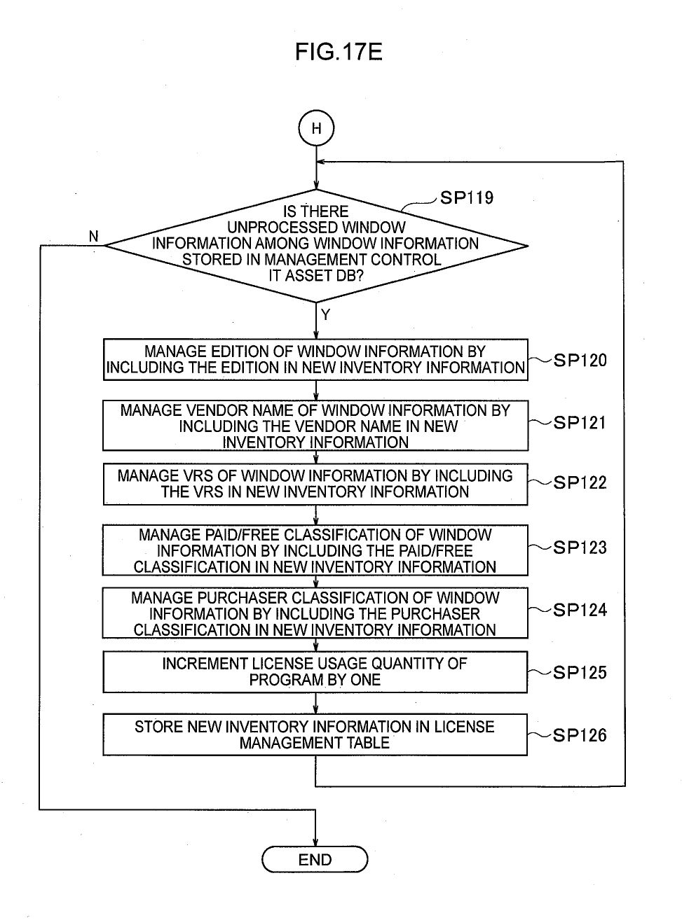

FIG. 17A to FIG. 17E show flowcharts of the license management table creation processing. The license management table creation processing is executed by the license management table creation unit 2112 of the IT asset management manager 211 when a predetermined set time has elapsed.

Foremost, the license management table creation unit 2112 determines whether there is any unprocessed input information among the input information 2211 stored in the management control IT asset DB 221 (SP81). Upon obtaining a negative result in the foregoing determination (SP81: N), the license management table creation unit 2112 proceeds to step SP100. Meanwhile, upon obtaining a positive result in the foregoing determination (SP81: Y), the license management table creation unit 2112 acquires the unprocessed input information, and additionally acquires the old inventory information related to the unprocessed input information (SP82).

As the specific processing of step SP82, for example, the license management table creation unit 2112 acquires, as the old inventory information related to the unprocessed input information, the old inventory information in which the header information and the program name included in the unprocessed input information are the same.

Next, the license management table creation unit 2112 acquires the window information related to the unprocessed input information (SP83). As the specific processing of step SP82, for example, the license management table creation unit 2112 acquires, as the window information related to the unprocessed input information, the window information in which the header information and the program name included in the unprocessed input information are the same.

Next, the license management table creation unit 2112 acquires information related to the edition from the input information acquired in step SP81 to step SP83, as well as from the old inventory information and the window information related to the acquired input information. The edition in the window information is stored as the window title and label text. Subsequently, the license management table creation unit 2112 determines whether the acquired edition is the same (SP84).

Upon obtaining a positive result in the determination of step SP84 (SP84: Y), the license management table creation unit 2112 manages the edition included in the input information by including such edition in the new inventory information to be managed by the management server 20 (SP85). Meanwhile, upon obtaining a negative result in the foregoing determination (SP84: N), the license management table creation unit 2112 manages the edition included in the window information by including such edition in the new inventory information (SP86).

Next, the license management table creation unit 2112 acquires information related to the vendor name from the input information acquired in step SP81 to step SP83, as well as from the old inventory information and the window information related to the acquired input information. Subsequently, the license management table creation unit 2112 determines whether the acquired vendor name is the same (SP87).

Upon obtaining a positive result in the determination of step SP87 (SP87: Y), the license management table creation unit 2112 manages the vendor name included in the input information by including such vendor name in the new inventory information (SP88). Meanwhile, upon obtaining a negative result in the foregoing determination (SP87: N), the license management table creation unit 2112 manages the vendor name included in the window information by including such vendor name in the new inventory information (SP89).

Next, the license management table creation unit 2112 acquires information related to the VR (version/revision) from the input information acquired in step SP81 to step SP83 as well as from the old inventory information and the window information related to the acquired input information. Subsequently, the license management table creation unit 2112 determines whether the acquired VR is the same (SP89).

Upon obtaining a positive result in the determination of step SP89 (SP89: Y), the license management table creation unit 2112 manages the VR included in the input information by including such VR in the new inventory information (SP90). Meanwhile, upon obtaining a negative result in the foregoing determination (SP89: N), the license management table creation unit 2112 manages the VR included in the window information by including such VR in the new inventory information (SP91).

Next, the license management table creation unit 2112 acquires information related to the paid/free classification from the input information acquired in step SP81 to step SP83, as well as from the old inventory information and the window information related to the acquired input information. Subsequently, the license management table creation unit 2112 determines whether the acquired paid/free classification is the same (SP92).

Upon obtaining a positive result in the determination of step SP92 (SP92: Y), the license management table creation unit 2112 manages the paid/free classification included in the input information by including such paid/free classification in the new inventory information (SP93). Meanwhile, upon obtaining a negative result in the foregoing determination (SP92: N), the license management table creation unit 2112 manages the paid/free classification included in the window information by including such paid/free classification in the new inventory information (SP94).

Next, the license management table creation unit 2112 acquires information related to the purchase classification from the input information acquired in step SP81 to step SP83, as well as from the old inventory information and the window information related to the acquired input information. Subsequently, the license management table creation unit 2112 determines whether the acquired purchase classification is the same (SP95).

Upon obtaining a positive result in the determination of step SP95 (SP95: Y), the license management table creation unit 2112 manages the purchase classification included in the input information by including such purchase classification in the new inventory information (SP96). Meanwhile, upon obtaining a negative result in the foregoing determination (SP95: N), the license management table creation unit 2112 manages the purchase classification included in the window information by including such purchase classification in the new inventory information (SP97).

Next, the license management table creation unit 2112 refers to the usage quantity column 22147 of the license management table 2214 and increments the license usage quantity of the programs that have been processed up to such point in time by one (+1) (SP98), and stores, in the license management table 2214, the edition, the vendor name, the VR, the paid/free classification and the purchase classification which were included in the new inventory information in the foregoing processing (SP81 to step SP97) (SP99).

Note that the license management table creation unit 2112 may also determine, prior to executing step SP98, whether or not the license granted to the program to be processed is a personal license. The term “personal license” refers to a license that is granted to each user, and not a license that is granted for each computer 10. Upon making the foregoing determination, the license management table creation unit 2112 may, for instance, refer to the personal license application program list information that is prepared in advance.

When the license granted to the program to be processed is a personal license, the license management table creation unit 2112 acquires the login user of the computer 10 holding the license that has already been counted in the usage quantity column 22147 at such point in time. Subsequently, the license management table creation unit 2112 determines whether the acquired login user is the same as the login user of the program to be processed. Upon obtaining a positive result in the foregoing determination, the license management table creation unit 2112 does not increment the license usage quantity of the program by one.

Next, the license management table creation unit 2112 determines whether there is any unprocessed old inventory information among the old inventory information 2213 stored in the management control IT asset DB 221 (SP100). Upon obtaining a negative result in the foregoing determination (SP100: N), the license management table creation unit 2112 proceeds to step SP119. Meanwhile, upon obtaining a positive result in the foregoing determination (SP100: Y), the license management table creation unit 2112 acquires the unprocessed old inventory information, and acquires the window information related to the unprocessed old inventory information (SP101).

As the specific processing of step SP101, for example, the license management table creation unit 2112 acquires, as the old window information related to the unprocessed old inventory information, the window information in which the header information and the program name included in the unprocessed old inventory information are the same.

Next, the license management table creation unit 2112 acquires information related to the edition from the old inventory information acquired in step SP100 and step SP101 and from the window information related to the acquired old inventory information. Subsequently, the license management table creation unit 2112 determines whether the acquired edition is the same (SP102).

Upon obtaining a positive result in the determination of step SP102 (SP102: Y), the license management table creation unit 2112 manages the edition included in the old inventory information by including such edition in the new inventory information (SP103). Meanwhile, upon obtaining a negative result in the foregoing determination (SP102: N), the license management table creation unit 2112 manages the edition included in the window information by including such edition in the new inventory information (SP104).

Next, the license management table creation unit 2112 acquires information related to the vendor name from the old inventory information acquired in step SP100 and step SP101 and from the window information related to the acquired old inventory information. Subsequently, the license management table creation unit 2112 determines whether the acquired vendor name is the same (SP105).

Upon obtaining a positive result in the determination of step SP105 (SP105: Y), the license management table creation unit 2112 manages the vendor name included in the old inventory information by including such vendor name in the new inventory information (SP106). Meanwhile, upon obtaining a negative result in the foregoing determination (SP105: N), the license management table creation unit 2112 manages the vendor name included in the window information by including such vendor name in the new inventory information (SP107).

Next, the license management table creation unit 2112 acquires information related to the VR from the old inventory information acquired in step SP100 and step SP101 and from the window information related to the acquired old inventory information. Subsequently, the license management table creation unit 2112 determines whether the acquired VR is the same (SP108).

Upon obtaining a positive result in the determination of step SP108 (SP108: Y), the license management table creation unit 2112 manages the VR included in the old inventory information by including such VR in the new inventory information (SP109). Meanwhile, upon obtaining a negative result in the foregoing determination (SP108: N), the license management table creation unit 2112 manages the VR included in the window information by including such VR in the new inventory information (SP110).

Next, the license management table creation unit 2112 acquires information related to the paid/free classification from the old inventory information acquired in step SP100 and step SP101 and from the window information related to the acquired old inventory information. Subsequently, the license management table creation unit 2112 determines whether the acquired paid/free classification is the same (SP111).

Upon obtaining a positive result in the determination of step SP111 (SP111: Y), the license management table creation unit 2112 manages the paid/free classification included in the old inventory information by including such paid/free classification in the new inventory information (SP112). Meanwhile, upon obtaining a negative result in the foregoing determination (SP111: N), the license management table creation unit 2112 manages the paid/free classification included in the window information by including such paid/free classification in the new inventory information (SP113).

Next, the license management table creation unit 2112 acquires information related to the purchase classification from the old inventory information acquired in step SP100 and step SP101 and from the window information related to the acquired old inventory information. Subsequently, the license management table creation unit 2112 determines whether the acquired purchase classification is the same (SP114).

Upon obtaining a positive result in the determination of step SP114 (SP114: Y), the license management table creation unit 2112 manages the purchase classification included in the old inventory information by including such purchase classification in the new inventory information (SP115). Meanwhile, upon obtaining a negative result in the foregoing determination (SP114: N), the license management table creation unit 2112 manages the purchase classification included in the window information by including such purchase classification in the new inventory information (SP116).

Next, the license management table creation unit 2112 refers to the usage quantity column 22147 of the license management table 2214 and increments the license usage quantity of the programs that have been processed up to such point in time by one (+1) (SP117), and stores, in the license management table 2214, the edition, the vendor name, the VR, the paid/free classification and the purchase classification which were included in the new inventory information in the foregoing processing (SP100 to step SP116) (SP118).

Next, the license management table creation unit 2112 determines whether there is any unprocessed unprocessed window information among the window information 2212 stored in the management control IT asset DB 221 (SP119). Upon obtaining a negative result in the foregoing determination (SP119: N), the license management table creation unit 2112 determines that the processing of all input information 2211, window information 2212 and old inventory information 2213 is complete, and then ends this processing.

Meanwhile, upon obtaining a positive result in the foregoing determination (SP119: Y), the license management table creation unit 2112 manages the edition, the vendor name, the VR, the paid/free classification and the purchase classification included in the window information by including such edition, vendor name, VR, paid/free classification and purchase classification in the new inventory information (SP120 to step SP124).

Subsequently, license management table creation unit 2112 refers to the usage quantity column 22147 of the license management table 2214 and increments the license usage quantity of the programs that have been processed up to such point in time by one (+1) (SP125), and stores, in the license management table 2214, the edition, the vendor name, the VR, the paid/free classification and the purchase classification which were included in the new inventory information (SP126).

The license management table creation unit 2112 thereafter once again determines whether there is any unprocessed window information among the window information 2212 stored in the management control IT asset DB 221, and ends this processing when there is no such unprocessed window information.

### (7) Effect of this Embodiment

As described above, according to the license management system 1 of this embodiment, each IT asset management agent 112 collects the input information 1211, the window information 1212 and the old inventory information 1213 and sends the collected information to the IT asset management manager 211, and the IT asset management manager 211 manages the licenses of the programs installed in the respective computers 10 based on the input information 2211, the window information 2212 and the old inventory information 2213 sent from each IT asset management agent 112.

Accordingly, in cases where the management of program licenses based only on the old inventory information 1213 would be insufficient, insufficient information can be supplemented with the input information 2211 and the window information 2212.

For example, in cases where “free trial version” is displayed on the screen upon activating the program, the IT asset management agent 112 can collect the window information 1212 capable of differentiating the paid/free classification. Thus, the IT asset management manager 211 can manage the program by differentiating the paid/free classification.

Moreover, in cases where “personal version” or “professional version” is displayed on the screen, the IT asset management agent 112 can similarly collect the window information 1212 capable of differentiating the change of version, and the IT asset management manager 211 can manage the program including the change of version.

Moreover, the IT asset management agent 112 can collect the input information 1211 by causing the user, when the program is to be installed, to input whether the program to be installed is corporate or individual. If there is no input, the installation is inhibited. Thus, the IT asset management manager 211 can manage the program by differentiating the corporate/individual classification.

### (8) Other Embodiments

(8-1) History Management of License Management Table

In the license management table creation processing (FIG. 17A to FIG. 17E) of the foregoing embodiment, a case was explained where one license management table 2214 (FIG. 10) is created, but the present invention is not limited thereto, and a plurality of license management tables 2214, with which the creation date is associated, may also be created. In the foregoing case, for example, when a new program is installed in the computer 10, or when the edition of a previously installed program is changed, it is possible to manage the history of the time that the program was added or changed.

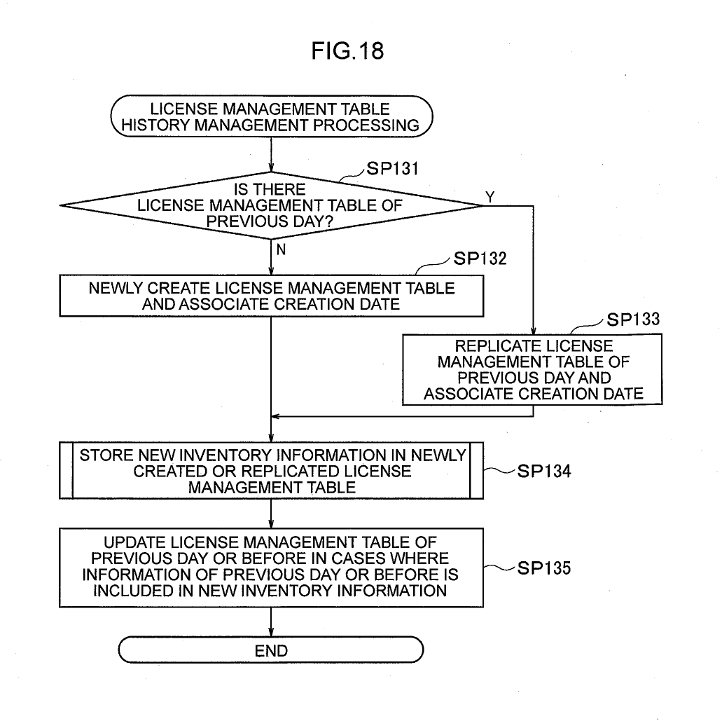

FIG. 18 shows a flowchart of the license management table history management processing. The license management table history management processing is executed by the license management table creation unit 2112 of the IT asset management manager 211 when a predetermined set time has elapsed.

Foremost, the license management table creation unit 2112 refers to the management control IT asset DB 221, and determines when the license management table 2214 of the previous day has been stored (SP131). Upon obtaining a positive result in the foregoing determination (SP131: Y), the license management table creation unit 2112 newly creates a license management table 2214 and associates the creation date with the created license management table 2214 (SP132).

Meanwhile, upon obtaining a negative result in the foregoing determination (SP131: N), the license management table creation unit 2112 replicates the license management table 2214 of the previous day and associated the creation date with the replicated license management table 2214 (SP133). Subsequently, the license management table creation unit 2112 stores the new inventory information in the newly created or replicated license management table 2241 (SP134). In step SP134, the license management table creation processing (FIG. 17A to FIG. 17E) explained in the foregoing embodiment is executed.

Next, the license management table creation unit 2112 updates the previously created license management table 2214 by including information of the previous day or before in the license management table 2214 of the previous day or before in cases where information of the previous day or before is included in the new inventory information (SP135), and then ends this processing.

(8-2) Usage Configuration of License Management

In the license management system overall processing (FIG. 11) of the foregoing embodiment, a case was explained where the IT asset management manager 211 creates the license management table 2214 (FIG. 10), and thereafter displays the license management table 2214 on the screen (FIG. 11: SP7), but the present invention is not limited thereto, and information related to the license of the program to be searched may also be presented.

In the foregoing case, it is possible to easily confirm information such as the number of licenses that need to be purchased, the number of licenses that are currently held, and excess licenses that may be offered to other business divisions (other organizations). It is thereby possible to effectively utilize IT assets.

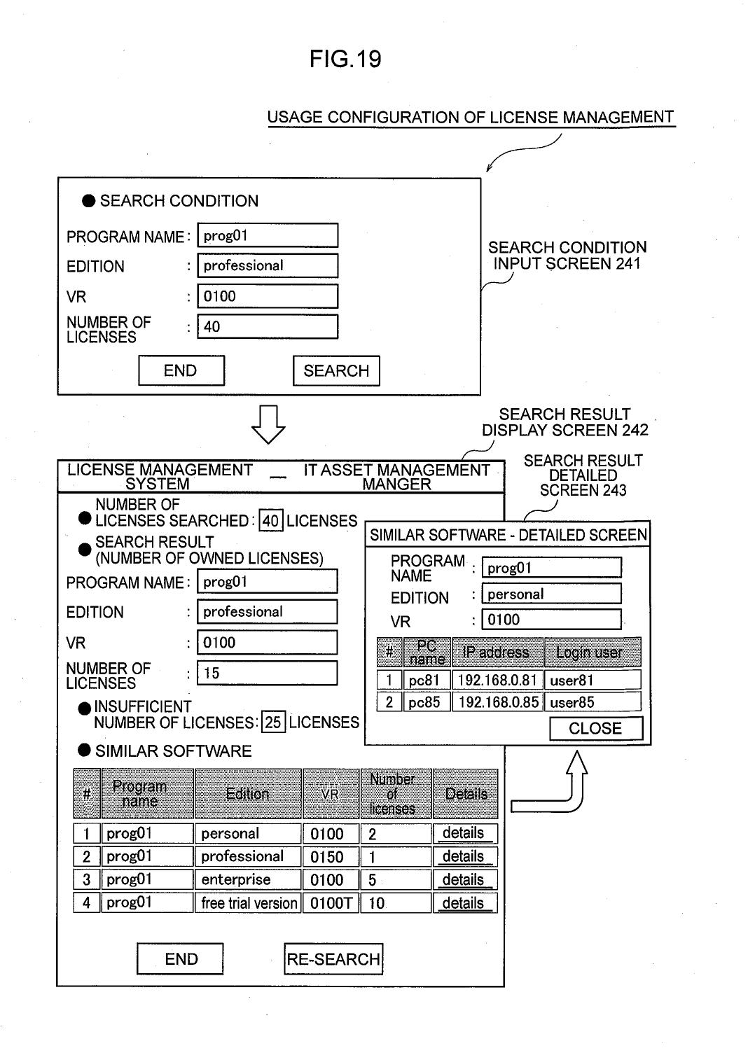

FIG. 19 shows a search condition input screen 241 for explaining an example of the usage configuration of license management. The search condition input screen 241 is displayed on the display screen of the display unit 24 by the output display unit 2113 of the management server 20. The search condition input screen 241 displays areas for inputting the program name, edition, VR and number of licenses of the program to be searched.

Here, FIG. 19 shows that “prog01” was input as the program name, “professional” was input as the edition, and “0100” was input as the VR of the program to be searched. Moreover, FIG. 19 shows that whether or not there are “40” licenses of the program will be searched.

When the user inputs the search conditions and presses the “Search” button, the output display unit 2113 searches the information of the licenses of the program to be searched based on the input search conditions and the license management table 2214, and displays the search result on the display screen. Here, the search condition input screen 241 is changed to the search result display screen 242.

The search result display screen 242 displays the number of licenses to be searched, the number of licenses currently held, insufficient number of licenses, and the license information of programs that are similar to the program to be searched. Here, FIG. 19 shows that, as a result of searching for whether or not there are “40” license of the program in which the program name of the program to be searched is “prog01”, the edition is “professional”, and the VR is “0100”, the currently held number of licenses is “15” licenses, and the insufficient number of licenses is “25” licenses.

Moreover, the search result display screen 242 additionally displays the license information of programs in which the program name is the same but the edition or the VR is different as the programs that are similar to the program to be searched. For example, FIG. 19 shows that the number of currently held licenses is “2” licenses regarding programs in which the program name is “prog01” and the same as the program to be searched, but the edition is “personal” and differs from the program to be searched.

When the user clicks the “details” column with a mouse or the like, the output display unit 2113 displays the search result detailed screen 243 on the display screen based on the new inventory information and the license management table 2214. The search result detailed screen 243 displays detailed information of the similar programs.

Note that, here, while the search result display screen 242 displays the insufficient number of licenses relative to the number of searched licenses, the number of excess licenses of a different edition may also be displayed as an included number of the insufficient number of licenses. In the foregoing case, in addition to being able to consider newly purchasing a license, it is also possible to consider the possibility of ensuring the required number of licenses by upgrading or downgrading the held licenses.

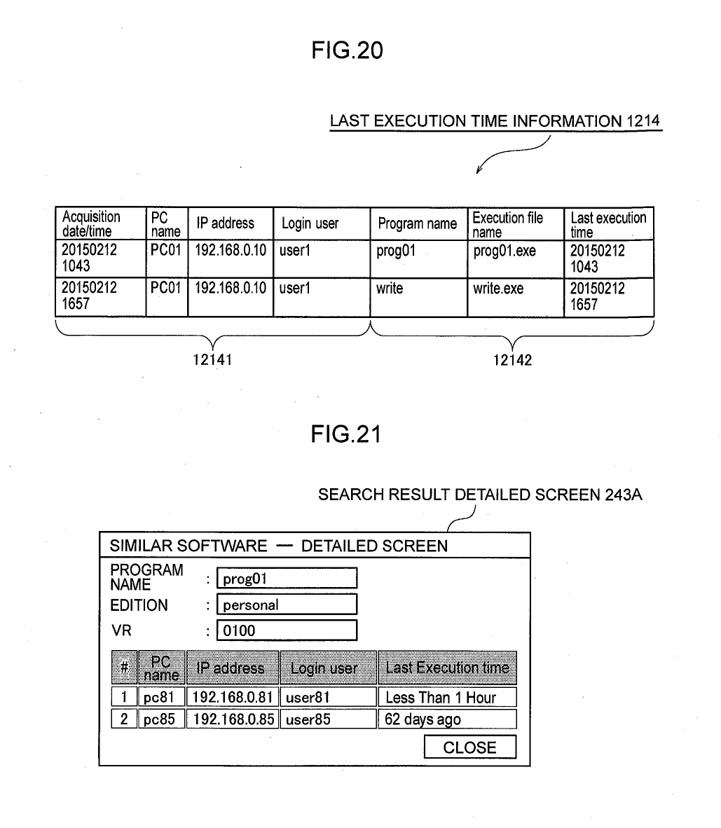

FIG. 20 shows last execution time information 1214 for explaining an example of the usage configuration of license management. The last execution time information 1214 is information that is collected by the IT asset management agent 112, and temporarily stored in the temporary IT asset DB 121. Moreover, after the information is stored in the temporary IT asset DB 121, the stored information is sent to the IT asset management manager 211 of the management server 20.

The last execution time information 1214 is configured from a header column 12141 and an execution time information column 12142. The header column 12141 stores information such as the acquisition date/time, computer name (PC name), IP address and login user similar to the header column 12111 of the input information 1211. Moreover, the execution time information column 12142 stores the program name, the executed file name and the last execution time of the executed program.

Accordingly, in the case of FIG. 20, for example, the execution file name of the program having the program name of “prog01” is “prog01.exe”, and the time that this program was last executed was at “10:43 on Feb. 12, 2015”.

FIG. 21 shows a search result detailed screen 243A for explaining an example of the usage configuration of license management. The search result detailed screen 243A differs from the search result detailed screen 243 (FIG. 19) with respect to the point that the “last execution time” is displayed. When the user clicks the “details” column on the search result display screen 242 with a mouse or the like, the output display unit 2113 displays the search result detailed screen 243A, including the last execution time, on the display screen based on the new inventory information including the last execution time information 1214, and the license management table 2214.

By confirming the search result detailed screen 243A, the user and utilize IT assets by offering licenses of programs, which have not been used for a long time, to other business divisions.

Note that, here, while the search result detailed screen 243A displays the last execution time of a specific program in all computers 10, the present invention is not limited thereto, and, for instance, only the computers 10 in which the last execution time is one month or before may be displayed. In the foregoing case, it is possible to easily identify computers that are being unnecessarily licensed.

### REFERENCE SIGNS LIST

1 License management system
10 Computer
112 IT asset management agent
121 Temporary IT asset DB
1211 Input information
1212 Window information
1213 Old inventory information
20 Management server
211 IT asset management manager
221 Management control IT asset DB
2214 License management table

1. A license management system configured from a plurality of computers which execute a program, and a management server which manages a license of the program executed by the plurality of computers,
wherein the plurality of computers comprise an agent which collects information related to the license of the program,
wherein the agent:
when the program is to be installed, determines whether or not input information required for identifying a feature of the program has been acquired, and inhibits the installation of the program when the input information has not been acquired;
constantly records a picture displayed on a display screen of the computer, and acquires window information required for identifying the feature of the program from the recorded picture;
sends the input information and the window information, including inventory information, to the management server,
wherein the management server comprises a manager which manages the license of the program, and
wherein the manager:
receives inventory information sent from each agent of the plurality of computers, and manages the license of the program executed by the plurality of computers based on the inventory information.

2. The license management system according to claim 1,
wherein the agent:
when the program is to be installed, displays, on a display screen, an input information pop-up window for a user to input information of any or all items among purchaser classification, program name, edition and license key, and urges the user to input the information, and acquires, as the input information, the information that was input by the user via the input information pop-up window.

3. The license management system according to claim 2,
wherein the agent:
constantly monitors a character string on a window displayed on the display screen of the computer;
when the character string on the window relates to the installation of the program, invalidates the user's operation to the window including the character string, and displays the input information pop-up window on the display screen; and
when the input information is acquired via the input information pop-up window, clears the input information pop-up window from the display screen, and cancels the disablement of the user's operation to the window.

4. The license management system according to claim 1,
wherein the agent:
extracts information of any or all items among window title, label text, menu text, menu text color, button text, button text color and text during program activation from the picture displayed on the display screen of the computer, and acquires the extracted information as the window information.

5. The license management system according to claim 4,
wherein the agent:
when constantly recording the picture displayed on the display screen of the computer, creates a picture file of predetermined units by separating the picture into predetermined units, divides the picture file of predetermined units according to a number of windows included in the picture file or a number of objects included in the window, additionally divides the divided picture files into predetermined units, extracts character strings from the divided picture files, and, when there are similar character strings among the extracted character strings, acquires the character string extracted from the picture file of a latest time as the window information.

6. The license management system according to claim 1,
wherein the agent:
extracts information of any or all items among login user name, file name, vendor name, program name, version/revision information and license information from a registry or a file system of the computer, and acquires the extracted information as the inventory information.

7. The license management system according to claim 6,
wherein the agent:
when it is possible to acquire a file path of the program from the file system, extracts an execution file name of the program from the file path, and includes the extracted execution file name in the inventory information.

8. The license management system according to claim 1,
wherein the manager:
manages any or all items among program name, edition, version/revision information, vendor name, paid/free classification, purchase classification and license usage quantity of the program being executed by the plurality of computers based on the inventory information sent from each agent of the plurality of computers.

9. The license management system according to claim 8,
wherein the manager:
when information of any or all items among the edition, the version/revision information, the vendor name, the paid/free classification or the purchase classification is different upon comparing the input information and the window information, manages the different information based on the window information.

10. The license management system according to claim 1,
wherein the manager:
when information related to the program being executed by the plurality of computers is designated as a search condition, displays, on the display screen, information of the license being managed regarding the designated program.

11. The license management system according to claim 10,
wherein the manager:
displays, on the display screen, information of the license being managed regarding the program designated as the search condition, and additionally displays, on the display screen, information of the license being managed regarding programs that are similar to the designated program.

12. A license management method to be executed by a plurality of computers which execute a program, and a management server which manages a license of the program executed by the plurality of computers, comprising:
a first step of the plurality of computers, when the program is to be installed, determining whether or not input information required for identifying a feature of the program has been acquired, and inhibiting the installation of the program when the input information has not been acquired;
a second step of the plurality of computers constantly recording a picture displayed on a display screen of the computer, and acquiring window information required for identifying the feature of the program from the recorded picture;
a third step of the plurality of computers sending the input information and the window information, including inventory information, to the management server; and
a fourth step of the management server receiving inventory information sent from each agent of the plurality of computers, and managing the license of the program executed by the plurality of computers based on the inventory information.
